(19) United States
(12) Patent Application Publication
(10) Pub. No.: US 2003/0177496 A1
(43) Pub. Date: Sep. 18, 2003

(54) Video presentation environment

(76) Inventor: Steven K. Lee, Minneapolis, MN (US)

Correspondence Address: Beck & Tysver, P.L.L.C., Suite 100, 2900 Thomas Avenue S., Minneapolis, MN, 55416, US

(21) Appl. No.: 10/358,931

(22) Filed: Feb. 5, 2003

Related U.S. Application Data
(60) Provisional application No. 60/354,595, filed on Feb. 5, 2002.

(51) Int. Cl. G06F 3/00; H04N 5/445; G06F 13/00; H04N 7/173

(52) U.S. Cl. 725/60; 725/37; 725/109

(57) ABSTRACT

An interactive video environment provides information to users about the set up and operation of digital devices and provides information about products and services to complement a digital device the user has purchased. The video environment features a host personality and the user may customize a video environment by selecting a host from a pre-defined set of hosts. The video environment is used in at least three modes: 1) to assist the user in making a product selection; 2) to assist the user in setting up a new digital device; and 3) to provide the user with additional information after purchase.

### FIELD OF THE INVENTION

The present invention relates generally to delivering customized marketing materials and content to a customer and more particularly to a method and system for a business to communicate to and with a customer, particularly post-sale, using customized content. This content is delivered preferably through DVD or other media which stores audio/video content and can be programmed for interaction with a user. Further, the content is delivered preferably through a customer-selected host personality or voice. Still further, the content may, at least in part, be related to the product purchased by a customer, the setup of the product, or additional products and services that cooperate with the purchased product.

### BACKGROUND OF THE INVENTION

Digital devices (for example: personal computers, personal digital assistants (PDAs), digital cameras, cell phones) are common, with many consumers having several such devices. While these devices are intended to provide convenience, it can be challenging for a user to master the operation of each such device that they own. For some consumers, the complexity of the operation of such devices is a barrier to purchasing a digital device. Many consumers purchase new devices on a regular basis as the devices improve from generation to generation or to replace a damaged device and thus the users are often presented with the challenge of learning how to operate a new device or how to exploit its features. Shopping for a digital device can be challenging as well, as consumers try to understand the advantages of one brand over another and to understand what features are provided with each device. Still further, often a primary product can work advantageously in concert with related or complementary products or services of which the user might not be aware.

Consumers often have only limited access to training materials or other helpful information about their primary product once they have left the purchase site. For computer purchases, this is of particular concern because computers require setup and because a computer's usefulness, purpose and capabilities can be dramatically expanded through auxiliary products such as additional hardware, software, services and applications. Instructional videos have been and are available, but such videos generally require that the computer be located in close proximity to a television set and a VCR or DVD player. Instructional computer software has long been available, but the use of a software program to explain another software program can be intimidating to new users and typically is not of particular help in the customer's setup of the computer out of the box. This is particularly true in cases where usefulness of this software material requires a “live” Internet connection to a remote file or application server for interactivity that demands a knowledgeable user's interaction to enable. Still further, the on-board or pre-loaded “Help” function that typically accompanies digital devices (and software for digital devices) is typically textual —not audio-visual. New computer video technologies allow traditional video programming and interactive video programming to be played on a computer. However, there has been an unfulfilled need for a fully interactive instructional video programming environment on a computer before, during and after the time of sale, without the requirement to establish a “live” Internet connection.

Other types of secondary, complementary products, services and applications also present customers with a need for more information after purchase. For example, many people are still unfamiliar with the benefits of broadband Internet connections, in-home installation and application services, or entertainment services subscriptions. To assist the user with in-home installation and with the investigation, purchase and installation of these complementary items, additional explanation and demonstration are required. Very often this additional explanation is impossible due to the lack of purchaser awareness that the service or application exists, or because the purchaser does not have the time and inclination to entertain a proper presentation while shopping in a busy retail environment. Additional difficulties arise when the presenter of these service and applications is not of the quality that piques and holds the potential purchaser's interest.

An opportunity for the user to maximize the capabilities of their primary product and for the seller to maximize profit from the sale of a primary product can be seized through sales of secondary products, particularly those related in some respect to the primary product. For example, when a computer owner buys a second and third computer for his/her home or office, the computer owner usually requires assistance before selecting the computer to make sure it works with the printer, scanner and/or other accessories that the he/she already owns. More recently, a need to connect multiple computers together in a “Local Area Network” through additional networking components and software products has been on significant rise. For these and other reasons, a customer who purchases a computer is likely to be in the market for goods and services that allows the purchaser to have the new and existing computers cooperate together. The purchaser is also likely to be in the market for or would benefit from other goods and services like an extended warranty, computer peripherals, software including games and other entertainment vehicles like DVDs, an MP3 player and the like. As an analogous example in the sporting goods business, a customer who purchases a snowboard is likely to be in the market for boots, gloves, goggles, lift tickets, lessons at snowboarding venues, travel packages to snowboarding venues, and for snowboarding information such as information about waxing, venues, and news about snowboarding; experienced snowboarders might appreciate information about how to execute advanced tricks and information about competition opportunities.

For the purchaser to get optimal functionality from their primary product, and for sellers to capture the greatest profit from the primary sale, it is advantageous for a seller to advise customers of secondary products at the time they are making the purchase of the primary product; due to time constraints, especially in a busy retail shopping environment, this is not always possible. Typically, a customer making a computer purchase in a retail setting spends less than twenty minutes in the store while making that purchase. Thus, there is an extremely limited time frame in which the sales staff at the retail store can introduce the customer to the computer services and peripherals that are available for purchase. In general, it is difficult to move beyond making a sales presentation for the computer and one secondary product, such as an extended warranty, in the limited time available for face-to-face customer interaction.

### SUMMARY OF THE INVENTION

The present invention addresses the customer's need for more information regarding a primary product and for information about secondary products and services that will allow them to get enhanced capabilities from their primary product. In addition, the present invention solves the problem of having the right person present to propose the right solution, in sufficient detail, with appropriate panache at the right time.

According to one aspect of the invention, video content features a host personality. The video, including audio, of the host personality is preferably divided into topic-specific segments, and the segments can be navigated by the user and selected via icons, text or other types of clickable or touchable hot spots on a screen displaying the video. Preferably, when adapted for user instruction, the host personality delivers the instructional information, such that the user has an experience like that of listening to a live human presenter, and the user does not have to read text, beyond menu items, to elicit the desired information.

According to another aspect of the invention, a video environment is hosted by a personality. This personality is selected by the user or customer from a pre-defined list of personalities. The personalities may be celebrities.

According to a further aspect of the invention, a user selects a personality from a pre-defined list of personalities, and this personality choice is stored in a database in association with user-identifying information. Subsequently, content presented via the video environment hosted by this selected personality are provided to the user.

According to still another aspect of the invention, a multi-mode approach is used to communicate to a user or consumer. In one mode, a video presentation plays at the point-of-sale site. In this mode, the video presents product information to assist the consumer in making a purchase decision, such as product feature and product comparison information. Further, the point-of-sale presentation may advise consumers of products or services that are related to, or complementary with, the featured product. A second out-of-the-box mode provides a video presentation pre-loaded on a digital device. The pre-loaded presentation launches upon startup, or can otherwise be accessed selectively by the user, to assist the user in the setup of the device and to provide the user with information regarding complementary products and services. In a third mode, additional video presentations are provided periodically to the user; these additional presentations feature information relating to the user's digital device or complementary products or services.

According to yet another aspect of the invention, a video presentation environment plays on a digital device and supplants the user interface of the operating system.

According to a further aspect of the invention, an information and service delivery platform includes interactive video stored on a storage device that is in data communication with a digital device. The video provides information regarding the operation of the digital device. When the delivery platform is accessed, a user interface supplants the interface of the digital device's operating system to display the video. Navigational controls on the screen allow the user to selectively control the play of said video.

According to yet another aspect of the invention, an information and service delivery platform provided in conjunction with a digital device includes interactive video that is divided into segments. A user interface identifies these segments and navigational controls allow the user to select a video segment to play.

According to a further aspect of the invention, an information and service delivery platform features a dedicated button on the hardware of a digital device, such as on the computer or monitor or housing, for accessing a video environment, particularly for providing video content relating to the setup of the digital device.

According to another aspect of the invention, a method for providing information or purchasing opportunities to a customer after the customer has purchased a primary product, includes the steps of a) providing a database containing a record associated with the purchase; b)providing the user with a choice of host from a predefined set of hosts; and c) recording the user's host choice in association with the purchase record.

According to another aspect of the invention, a system links a digital device owner to auxiliary materials for that device. The system includes interactive video bearing a link via the Internet to a remote digital device, such as to an application server or to a web site that provides information regarding services or products related to the user's digital device.

### BRIEF DESCRIPTION OF THE DRAWINGS

An exemplary version of a video environment for use with a digital device is shown in the figures wherein like reference numerals refer to equivalent structure throughout, and wherein:

FIG. 1 is a diagram illustrating components of the video environment and showing the video environment in conjunction with a digital device;

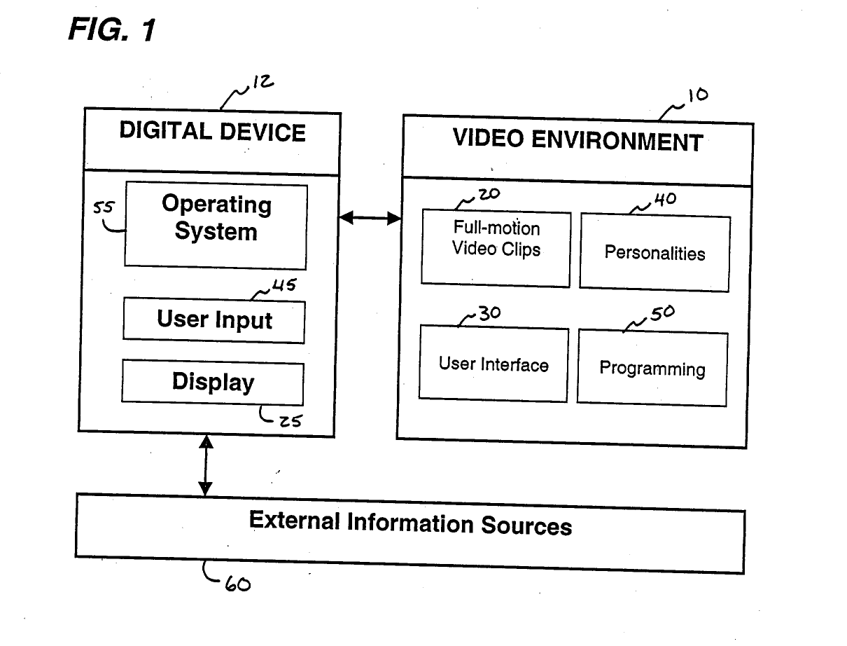

FIG. 2 is diagram illustrating three modes of using the video environment; and

FIG. 3 is a flow chart depicting a process by which a customized video environment is provided to a user.

### DETAILED DESCRIPTION OF PREFERRED EMBODIMENT(S)

An interactive video environment 10 is provided for a digital device 12. “Digital device” 12 includes personal computers, personal digital assistants (PDAs), digital cameras, cell phones, and any other device through which users access data that is visually displayed. The video environment 10 presents information or content to a user via full-motion video clips 20 displayed on a screen or monitor 25. Preferably, the screen or monitor 25 is the same screen or monitor that the user uses in conjunction with their digital device. For example, for a PDA, the video environment 10 plays on the PDA's screen; for a computer, the video environment 10 plays on the primary monitor connected to the computer. In this manner, information is delivered to the user without the user having to read paragraphs of textual information. Preferably, the video content 20 of the video environment is segmented by topic. A user interface 30 of the video environment 10 presents menu items affiliated with the topic segments and allows the user to access selected segments of interest by clicking on or otherwise selecting a menu item using a user input device 45 in data connection with the digital device 12.

The preferred video environment 10 is hosted by a “personality” 40 such as an actor, athlete, musician, scientist, celebrity, cartoon character, or the like. The personality's image and voice guide the user through the interactive video environment. In one embodiment, the user is offered the opportunity to select a personality from a set of pre-defined personalities 40.

In one embodiment, the interactive video environment 10 is stored on a transportable medium that can incorporate programming functions 50, such as on a CD-Rom or DVD disc or the like and any other such medium yet to be developed. An advantage of storing the video environment on a transportable medium is that it can be physically delivered to the customer, such as via post or delivery. Alternatively, at least for some types of primary products like computers, the interactive video environment can be pre-installed on the product's hard drive. For a “Configure-to-order” (CTO) personality for a computer, the personality can be loaded onto the hard drive before the delivery of the computer to the customer/end user. For the off-the-shelf version, the personality can be selected and loaded onto the computer at a help desk, or can be provided to the user on a removable media (e.g. DVD-ROM) that can be loaded onto the hard drive by the customer at home. If the personality is installed at home, the computer could contain a preloaded default personality that would be overwritten when the user-selected personality is installed.

In the context of a computer as the primary product, this interactive video environment is made easily accessible to the user without significant effort typically required to set up their computer. This access would be facilitated by a special button on the keyboard or user input device 45, or through clicking on a particular icon in the operating system environment. In a preferred embodiment, the user interface 30 of the video environment 10 supplants the user interface of the operating system 55 of the computer or digital device 12, such that the only control or navigational options apparent to the user are those afforded by the user interface 30 of the video environment 10. This enables simple, straightforward operation of the video environment 10.

The interactive video environment 10 interfaces seamlessly with external information sources 60, such as sites accessible via the Internet, to provide an enriching experience using an intuitive, easy to use user interface 30.

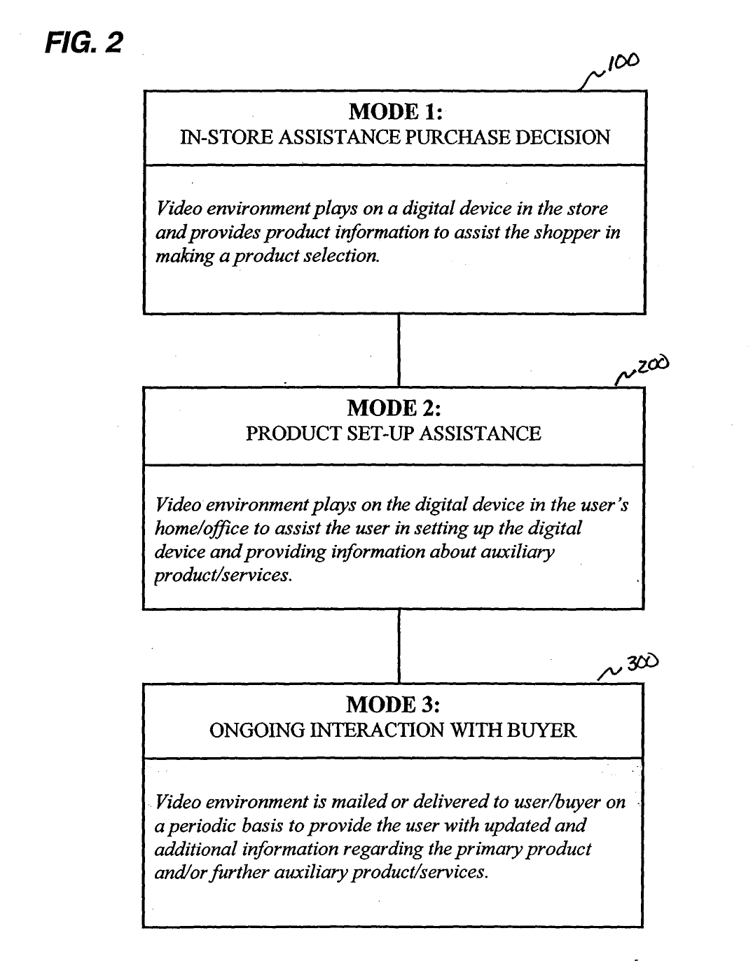

Ideally, the interactive video environment 10 has different modes or styles that correspond to the customer's varying needs through and after their purchase process. As illustrated in FIG. 2, a first mode 100 for the video environment 10 assists the customer by providing information about the product prior to the customer's purchase. This pre-sale mode 100 is of particular value for assisting in-store presentation of products, services and applications, where a user can interact with the product prior to purchase. The interactive video environment 10 is accessed in such a setting by, for example, triggering an additional, specially marked button on the computer or as part of the display. The interactive video environment 10 then presents information about the product, services or applications to inform the customer of these options, thereby building awareness of and assisting in the product selection. The presentation materials will be presented in an interactive manner, so that the potential customer can easily navigate to the information of greatest interest.

A second mode 200 of operation for the interactive video environment is as a smart, helpful friend to the customer who has purchased the primary product. In this mode, the interactive video environment 10 helps the user with typical initial product questions or setup activities. In the context of computer sales, for example, the interactive video environment 10 guides the user through the setup of the computer, and answers questions about how the computer and its software operate. Because this second mode 200 is for use by a customer who has already made a purchase of a primary product, its content can be delivered in a somewhat more personalized manner to facilitate understanding. One aspect of this personalization is the selection by the customer of a personality to “host” the interactive video environment, as described elsewhere herein.

A third mode 300 of operation for the interactive video environment 10 is as a exploration tool, helping the user to appreciate the full capabilities of the primary product he or she has purchased, as well as introducing the user to further possibilities for fully exploiting the primary product's capabilities through cooperation with secondary products, services and applications. For example, in the computer environment, this third mode 300 for the interactive video environment 10 operates when the user has a computer already set up. The video environment 10 might explain how useful a broadband connection to the Internet would be and can easily demonstrate its benefit without a real broadband connection present, or could suggest in-home installation services that may assist in a particularly complex integration of a previously purchased scanner, printer or computer within a “Local Area Network”. Because this third mode 300 of operation is for the customer's ongoing use, it preferably is still more personalized than the second mode 200 in that it requires significantly longer presentation time and much more presentation material depth.

The video environment 10 may be used in just one of the three modes 100, 200, 300 or in any two or more modes. To give the user a continuity in their experience with the video environment 10 in conjunction with the purchase of a digital device 12, the video environment 10 is employed in all three modes 100, 200, 300.

The preferred interactive video environment 10 is useful, interesting and entertaining such that a customer is inclined to use this interactive video environment 10 and to not delete it from their digital device.

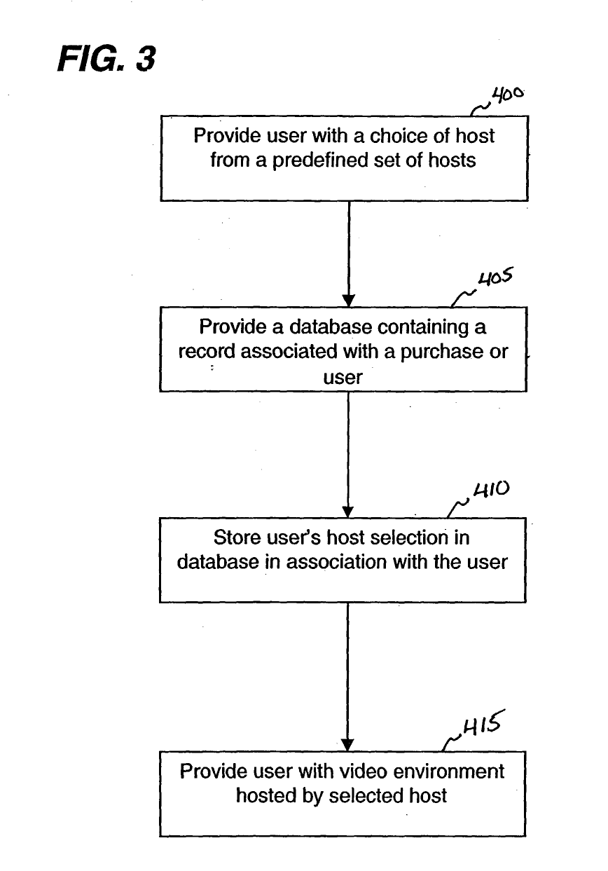

Another manner of making the video environment 10 appealing to users, is to customize it with a host personality of the user's choice, as noted above. FIG. 3 illustrates a process for providing a video environment hosted by user's chosen personality. In step 400, a user is provided with a choice of hosts from a predefined set of hosts. A database stores (405) a record associated with the user or with the purchase transaction. This record has an identifier. When the user has made a selection, the selection is stored (410) in association with the user's record or the transaction record. The user is then provided with a video environment (415) that is hosted by their selected personality. This method is particularly advantageous for providing hosted video environment content to the user on a periodic or subscription basis.

The interactive video environment preferably provides content that is targeted relatively specifically to the primary product with which it is associated. In the computer context, the video environment content may be specific to the particular computer (e.g. brand, model, pre-installed software) purchased by the consumer. The content might even be tailored specifically to the peripherals attached to the computer.

To generate targeted, specific, personalized content for the interactive video environment, the environment is connected to a database that tracks the user's primary product purchase. To further personalize content, the system may track and store the user's other related purchases. For example, in the computer context, the database would track the software and peripherals that the user has already purchased. Another way to generate personalized content is for the video environment to “learn” the desires, interests, preferences, and attitudes of the user. This could be accomplished by asking the user to fill out a database form, or could be “observed” from the user's selections inside the interactive video environment without requiring user intervention.

As noted above, the interactive video environment can provide to the user information about secondary products, applications and services that are likely to be of interest to the purchaser of the primary product. For example, in the computer context, the personality could both explain the benefits of high-speed Internet access and recommend that the user select a particular broadband Internet service provider. The video environment might then facilitate the user's connection, such as by connecting directly to a web site in which the sponsored ISP could be purchased or to include intelligence that would allow the purchase of the product or service without leaving the interactive video environment.

The interactive video environment 10 can be used as a tool to allow third parties to communicate with a user. For example, a third party might contract for space or time or video content on the video environment, particularly for video environment content that is related to the third party's products or services.

Another aspect of the invention involves a continued interaction with the user via the interactive video environment. This can be achieved, for example, by delivering new interactive video environment content on a periodic or subscription basis. An interactive video environment could be provided on a storage media such as CD-rom, DVD, and could be delivered by mail to the user's home or office. Preferably this subscription content is also personalized, such as by being hosted by the personality of the user's choice, and the content can be directed to material related to the primary product purchased by the user, or to material selected by the user, or to material presumed to be of interest to the user based on the user's selections in the video environment. Further, the user can select the frequency with which the new video environment content is delivered. For example, in the context of the primary product being a snowboard, the user might select the personality of Ross “The Boss” Powers, a popular snowboarding athlete, and might subscribe to receive update interactive video environments on a weekly basis. The new interactive video environments would contain, for example, updated news and video of Ross Powers at recent competitions, up-to-date interviews with Powers, news about recently released snowboarding products or products used by Powers, preferably with links or opportunities to purchase such secondary products via the video environment making a connection to a web site. Of course, the possibilities for the breadth and depth of the content is endless, and only a few examples are presented here.

The interactive video environment content can be delivered on any media that provides storage, programmability and playback. While it is possible for this invention to be executed using downloadable content and interaction via browser-based navigation on the Internet, such embodiment is not preferred due to the absence of such service, slow download times and the greater complexity of use that demands its users have greater computer skills than would be required to simply load a DVD and respond to prompts.

The terms “user”, “customer”, “consumer”, “purchaser”, “shopper” and the like are used interchangeably throughout.

Although an illustrative version of the device is shown, it should be clear that many modifications to the device may be made without departing from the scope of the invention.

I claim:

1. In conjunction with a digital device, an information and service delivery platform, comprising:
a) interactive video stored on a storage device that is in data communication with a digital device, said video providing information regarding the operation of the digital device;
b) a user interface which, when said delivery platform is accessed, supplants the interface of the digital device's operating system to display said video;
c) navigational controls for selectively controlling the play of said video.

2. An information and service delivery platform according to claim 1, wherein said video portrays a personality which hosts the video content.

3. An information and service delivery platform according to claim 1, wherein said video has segments and the user interface identifies these segments and the navigational controls allow the user to select a video segment to play.

4. An information and service delivery platform according to claim 1, wherein said navigational controls include one or more of the following functions: play, pause, stop, volume up, volume down, and volume mute.

5. An information and service delivery platform according to claim 1, further comprising a dedicated button on the digital device, said dedicated button being configured to launch said information and service delivery platform.

6. An information and service delivery platform according to claim 1, wherein said digital device is a personal computer.

7. An information and service delivery platform according to claim 6, wherein said button is located on the keyboard of the personal computer hardware.

8. An information and service delivery platform according to claim 1, wherein said digital device is a personal digital assistant.

9. An information and service delivery platform according to claim 1, wherein said digital device is a cellular telephone.

10. An information and service delivery platform according to claim 1, wherein said digital device is a digital camera.

11. A method for providing information to a customer after the customer has purchased a product, comprising the steps of:
a) providing a database containing a record associated with the purchase;
b) providing the user with a choice of host from a predefined set of hosts;
c) recording said host choice in association with said purchase record;
d) provide video environment content hosted by said selected host.
periodically sending the user information regarding goods and services that are complimentary to the purchased product with said content presented by said chosen host.

12. A method according to claim 11, further comprising the step of:
e) storing in a database said customer's selected host personality in association with said customer's mailing address;
f) mailing said customer a digital storage medium containing video hosted by said customer's selected host.

13. A method according to claim 11, further comprising the step of:
e) periodically sending the user information regarding goods and services that are complimentary to the purchased product with said content presented by said chosen host.

14. A method according to claim 11 wherein said digital storage medium is a CD-rom disc.

15. A method according to claim 11, wherein said digital storage medium is a DVD disc.

16. A system for providing assistance to a user for using their personal computer, comprising video showing a host personality verbally presenting information, such that the help information is not presented in the form of text for the user to read.

17. A system according to claim 16, wherein said video is divided into topic-specific segments, and wherein said video is interactive and provides a text menu for the user to select a topic to view a select video segment.

18. A system for linking a digital device owner to auxiliary materials for said device, said system comprising: interactive video providing a link via the Internet to a remote digital device.

19. A system according to claim 18, wherein said remote digital device is an application server.

20. A system according to claim 18, wherein said remote digital device is a web server providing information regarding services or related to the user's digital device.

21. A multi-mode method of interacting with a consumer, comprising the steps of:
a) providing a personality-hosted interactive video environment at the physical point-of-sale location, said environment providing product information to the consumer;
b) providing a personality-hosted interactive video environment pre-loaded on the user's purchased digital device;
c) periodically, providing to the user additional tailored video content.

22. A multi-mode method of interacting with a consumer according to claim 21, further comprising the steps of:
d) presenting user with a set of pre-defined host personalities;
e) storing said selected host personality in a database in association with a user identifier;
f) providing to the user an interactive video environment bearing video content hosted by said selected personality.
